(19) United States
(12) Patent Application Publication
(10) Pub. No.: US 2017/0103448 A1
(43) Pub. Date: Apr. 13, 2017

(54) MANAGING A GIFT BEING SPONSORED TO A DIRECTED RECIPIENT

(71) Applicant: Customer Motivators, LLC, Boynton Beach, FL (US)

(72) Inventor: James CASHION, Boca Raton, FL (US)

(21) Appl. No.: 15/290,460

(22) Filed: Oct. 11, 2016

Related U.S. Application Data
(60) Provisional application No. 62/240,247, filed on Oct. 12, 2015.

(51) Int. Cl. G06Q 30/06; H04L 12/58

(52) U.S. Cl. CPC G06Q 30/0641; H04L 51/08

(57) ABSTRACT

Various examples manage giving a gift from a sponsor to a recipient. In example, the sponsor of the gift gives access to a file with at least one participant or customer of the sponsor. The recipient of the gift, the participant, and the sponsor of the gift are all different entities. The system assigns a unique token to the participant. A first message with the unique token is sent to the participant. The message includes instructions on how send the gift to the recipient. The participant makes a selection of an identity of the recipient of the gift. A second message is sent to the recipient. The second message includes information that the participant is giving the recipient a gift from the sponsor and including information on how the recipient can select the gift. The recipient selects a gift. The gift is sent from the sponsor to the recipient.

### CROSS REFERENCE TO RELATED APPLICATIONS

This application is based upon and claims priority to U.S. Provisional Patent Application Ser. No. 62/240,247, entitled “Managing A Gift Being Sponsored To A Directed Recipient”, filed on Oct. 12, 2015, the disclosure of which is hereby incorporated by reference in its entirety.

### BACKGROUND

The present disclosure generally relates to the providing gifts, and more particularly relates to providing a gift being sponsored by a third party to an identified recipient using a computer network.

Many companies want to get customer and potential customer to take a certain action, like changing from paper electronic billing or electronic payment. Other companies may want to give back to specific groups in the community. The specific groups could be active military personnel, veterans, teachers, firefighters, first responders and others.

### BRIEF SUMMARY

Currently, there is not a solution in which a company sponsoring a gift can direct the gift to a specific group or a member of a specific group through their customer and prospective customer base.

The presently claimed invention is known as “Gift-It”. Various examples disclosed a novel system, computer program product, and method for managing giving a gift from a sponsor to a recipient. In example, the sponsor of the gift gives access to a file with at least one participant or customer of the sponsor. The sponsor may be a company trying to encourage a customer or client to switch to paper-less billing. Or an organization that just wants to give back to specific groups in the community, teachers, law enforcement, military, veterans, first responders, any other group sharing at least one common characteristic, or a combination thereof. The recipient of the gift, the participant, and the sponsor of the gift are all different entities. The system assigns a unique token to the participant. A first message with the unique token is sent to the participant. The message includes instructions on how send the gift to the recipient. The participant makes a selection of an identity of the recipient of the gift. A second message is sent to the recipient. The second message includes information that the participant is giving the recipient a gift from the sponsor. The second message includes information on how the recipient can select the gift. The recipient selects a gift. The gift is sent from the sponsor to the recipient.

The gift may be anything of value, such as, a gift certificate, discount, coupon, prepaid card, a check, or limited time offer.

It is important to note that the gift may be personalized. There are different levels of personalization. The system first personalizes message from the sponsor to the participant. Second the participant and/or sponsor message and gift can be personalized to the recipient.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one example of the present disclosure;

FIG. 2 is a block diagram illustrating a detailed view of a Gift-It Participant Manager;

FIG. 3 is an example overview of the Gift-It promotional material;

FIG. 4 is an example message inviting a participant to send a gift from a sponsor to a recipient of a gift;

FIG. 5 is an example message inviting a participant to select a recipient and a gift to send from the sponsor;

FIG. 6 is an alternate example message inviting a participant to select a recipient and a gift to send from the sponsor;

FIG. 7 is an example message notifying the participant that the gift was sent to the recipient;

FIG. 8 is an example message notifying the recipient that the gift was sent to them;

FIG. 9 is an alternate example message inviting a participant to select a joint gift from a sponsor for themselves and a recipient;

FIG. 10 is an operational flow diagram illustrating another example of an overall process for managing giving of the gift; and

FIG. 11 is an example block diagram illustrating one example of an information processing system.

### DETAILED DESCRIPTION

### Non-Limiting Definitions

The terms “a”, “an” and “the” are intended to include the plural forms as well, unless the context clearly indicates otherwise.

The term “gift” means a gift card, coupon, discount, or something else of value selected by the participant to give a recipient. The gift is at least partially financially supported by the sponsor. The gift may be a physical item, such as a store gift card, or coupon or discount that is delivered via email, a text message, a telephone message, a printed letter or combination thereof.

The term “message” means any communication via text, audio, video or other multimedia whether delivered as an advertisement, banner ad, email, a text message, a telephone message, a printed letter or combination thereof to the participate or customer. The message may be personalize to the participant or customer.

The term “participant” means a party that directs the gift being given by the sponsor to the recipient. The term “customer” is used interchangeably with “participant” sponsor because “customer” is a customer of the “client.”

The term “recipient” means a party to receive a gift or a portion of a gift from the sponsor. The recipient may be a friend, a teacher, a veteran, a solder or any other group, including a virtual community, such as social media group or real community such as family and friends.

The term “sponsor” means a party to support the recipient financially or through the provision of products or services. The term “client” is used interchangeably with “sponsor” because the “client” is using the services of this overall system 100 to have a participant send a gift to a recipient. The client could be any business wanted to promote their product or services.

### Operating Environment

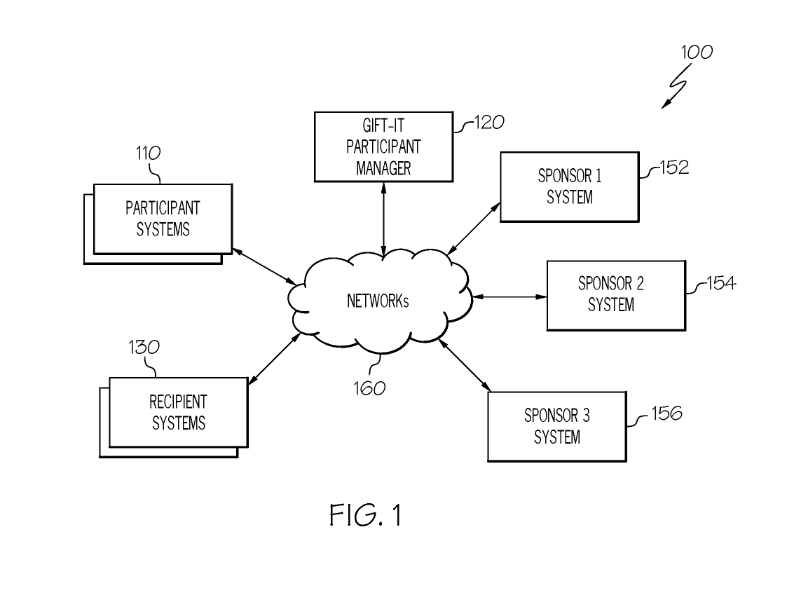

FIG. 1 illustrates one example of an operating environment 100 according to one example of the present disclosure. The operating environment 100, in this example, comprises a plurality of information processing systems 110, 120, 130, 152, 154, and 156 communicatively coupled to one or more networks 160. The information processing systems 110, 120, 130, 152, 154, and 156 comprise server systems, user systems, and/or the like. Examples of user systems include (but are not limited to) desktop computers; servers; portable computing devices such as laptop computers mobile/smart phones, tablets, wearable computing devices (e.g., smart watches), personal digital assistants, etc.; and the like. In one example, one or more of the information processing systems 110, 120, 130, 152, 154, and 156 are part of a cloud-computing environment or a non-cloud computing environment.

The network(s) 160 comprises a local area network (LAN), a general wide area network (WAN), and/or a public network (e.g., the Internet). The network(s) 160, in one example, also comprises a wireless communication network that supports any wireless communication standard such as, but not limited to, a Wireless Fidelity (WiFi) network, Global System for Mobile Communications (GSM), Code Division Multiple Access (CDMA), Time Division Multiple Access (TDMA), General Packet Radio Service (GPRS), Frequency Division Multiple Access (FDMA), Orthogonal Frequency Division Multiplexing (OFDM), or the like. The wireless communication network includes one or more networks based on such standards. For example, in one example, the wireless communication network comprises one or more of a Long Term Evolution (LTE) network, LTE Advanced (LTE-A) network, an Evolution Data Only (EV-DO) network, a GPRS network, a Universal Mobile Telecommunications System (UMTS) network, and the like.

At least one system is a Gift-It participant manager 120. The Gift-It participant manager 120 is a website and/ online application (e.g., a cloud-based application) or service (e.g., a cloud-based service) that allows participants or customers using system 110 of a sponsor to manage giving a gift to a recipient at a recipient system 130. Several specific components of the Gift-It participant manager are discussed in greater detail below. Note each of the sponsors system 152, 154, and 156 in one example are different business entities. In another example, they are related entities. Also the participant, the recipient and the sponsor are typically not related.

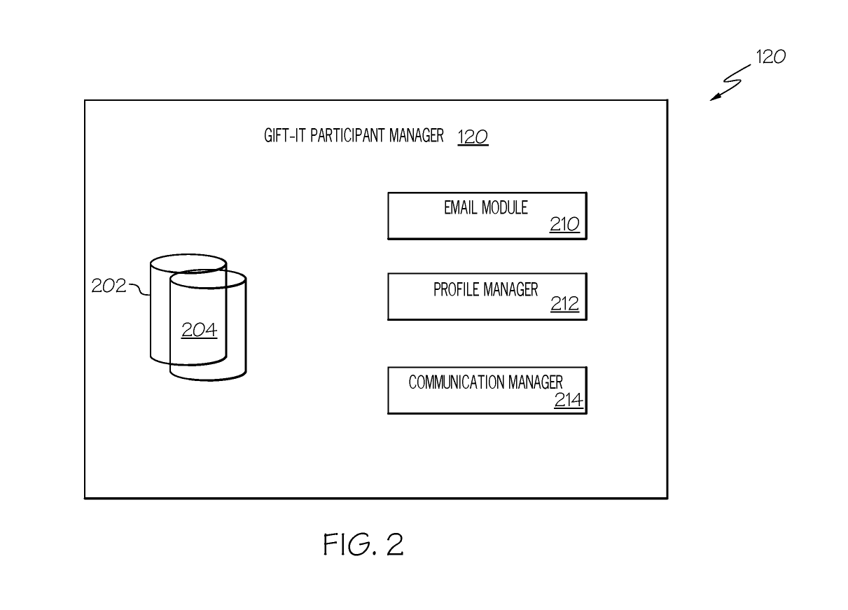

FIG. 2 is a block diagram 200 illustrating a detailed view of a Gift-It Participant Manager. The Gift-It Participant Manager 130 further comprises, among other things, participant information access from the sponsor systems 152, 154, and 156. These may be store in databases 202, 204. A messaging or email module 210 is included (e.g., an email application, a Short Message Service (SMS) messaging application, a Multimedia Messaging Service (MMS) messaging application, a network adapter, and/or the like) and a profile manager 212 communication manager 214.

It is important to note that the recipients in the databases 202, 204 can classify the group of recipients based on an affiliation to an organization military or veterans, or profession, or hobby, and other demographics include a zip code. In another example, the group of recipients may be a virtual community, such as social media group or real community such as family and friends.

### Overall Process

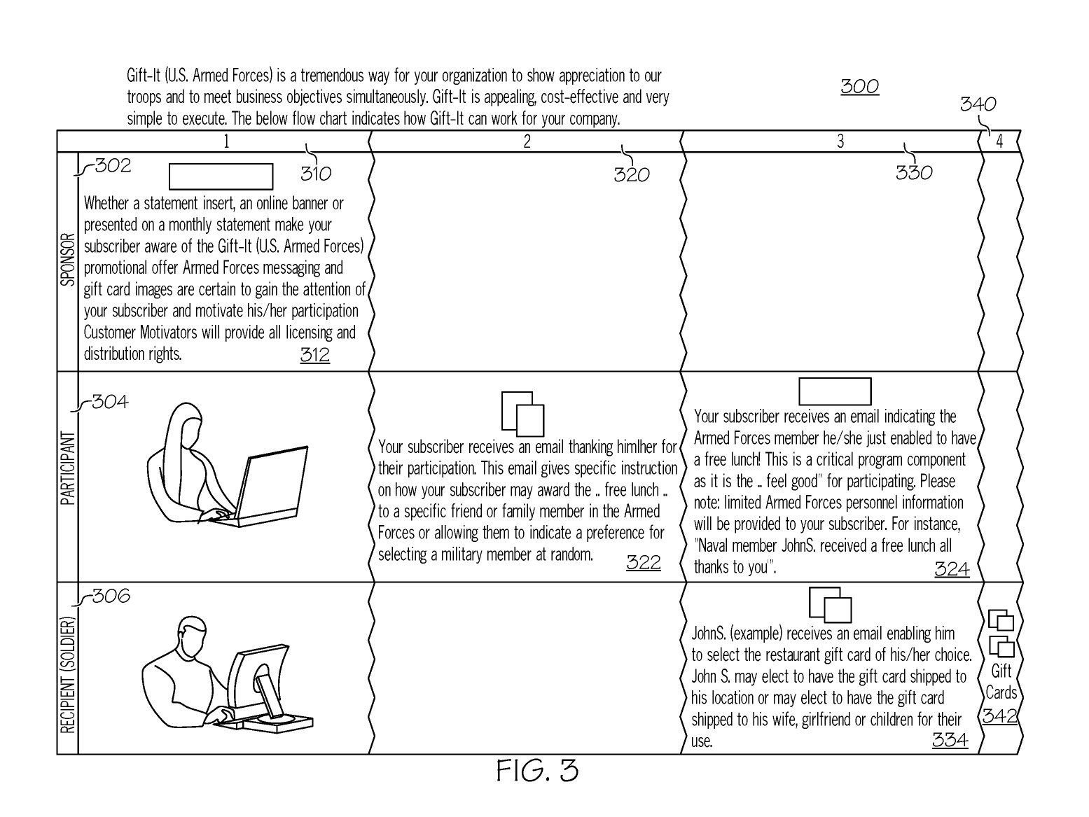

FIG. 3 is an example overview process of the Gift-It system. There are three rows Sponsor 302, Participant 304, and Recipient 306 and four columns 310, 320, 330, and 340 as shown. In this example the Sponsor 304 is a “client” of the provider of the present patent. The Participant 306 is a customer of the sponsor. The Recipient 306 in this example is s a soldier or veteran. The columns represent time going from left in column 1 to the end when the gift is delivered in column 340, item 342.

It is important to note that the gift may be personalized as shown. There are different levels of personalization. The system first personalizes message from the sponsor to the participant. Second the participant and/or sponsor message and gift can be personalized to the recipient.

### Example Messages

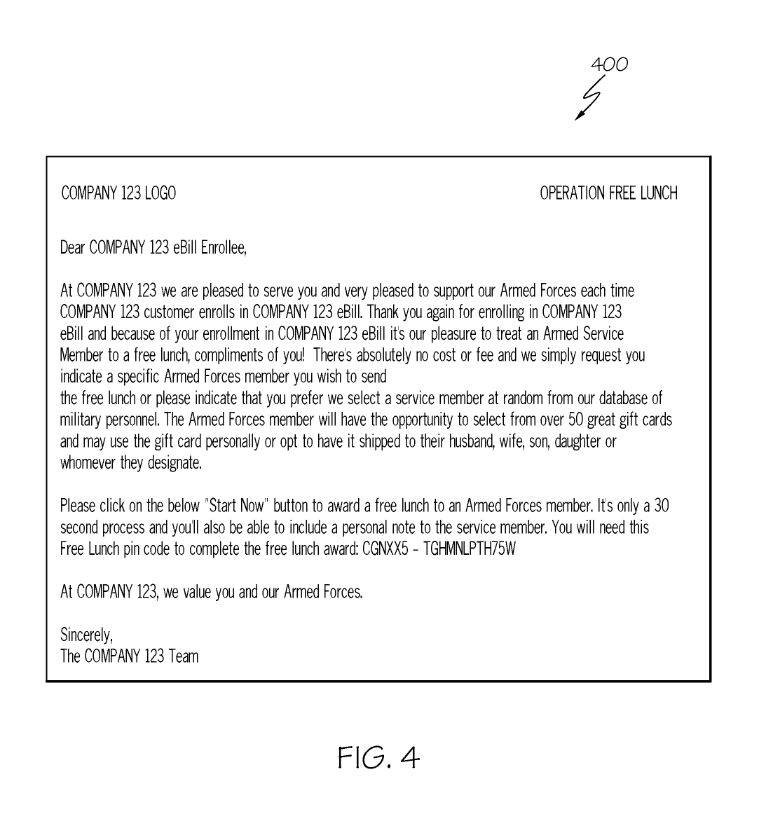

FIG. 4 is an example message 400 inviting a participant to send a gift from a sponsor to a recipient of a gift. This would be the can be an example message from the sponsor to a participant or prospective participant 312 in the Sponsor row 302 and column 302 of FIG. 3. The term message is broadly means the message can be delivered as an email, a text message, a telephone message, a printed letter or combination thereof to the participate or customer.

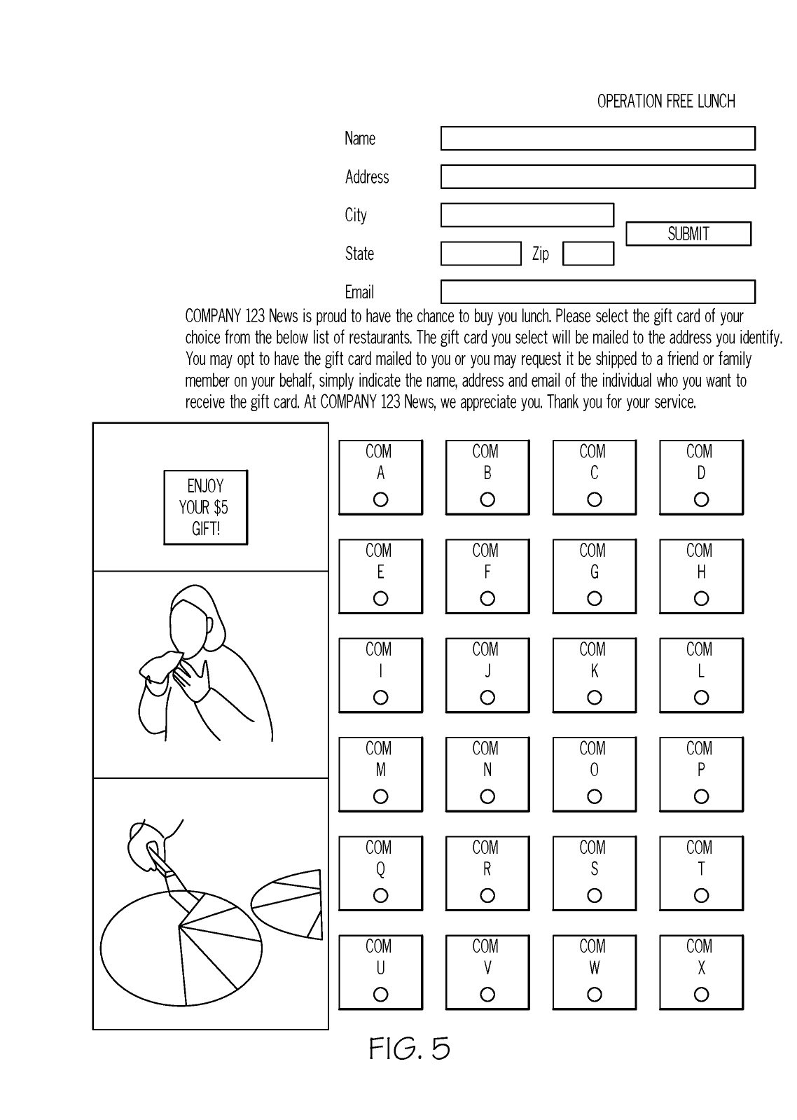

FIG. 5 is an example message 500 inviting a participant to select a recipient and a gift to send from the sponsor. This message 500 would be in addition to and provide further information to the message 400 of FIG. 4 or in place of it. Each of the 24 squares with text “COM A”, “COM B” . . . . “COM X”, represents an available gift to select. The recipient of the give is chosen in the top of the page.

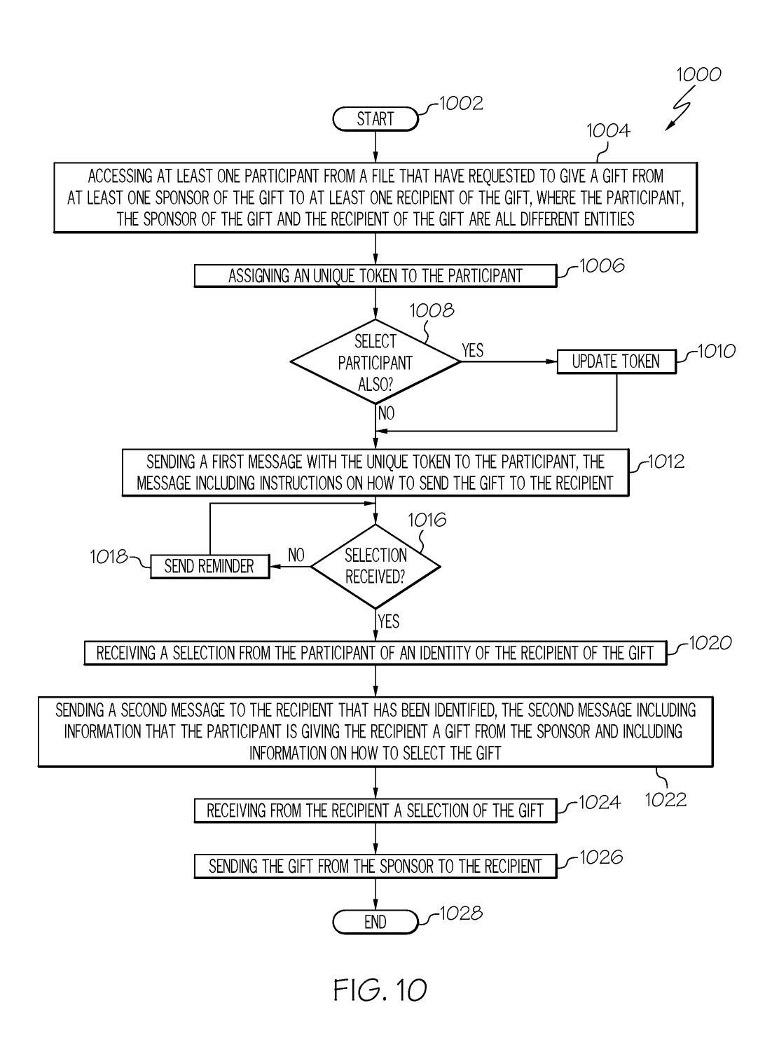

In another example, as is further described below with reference to FIG. 10, the participant may also receive a gift or portion of a gift from the sponsor.

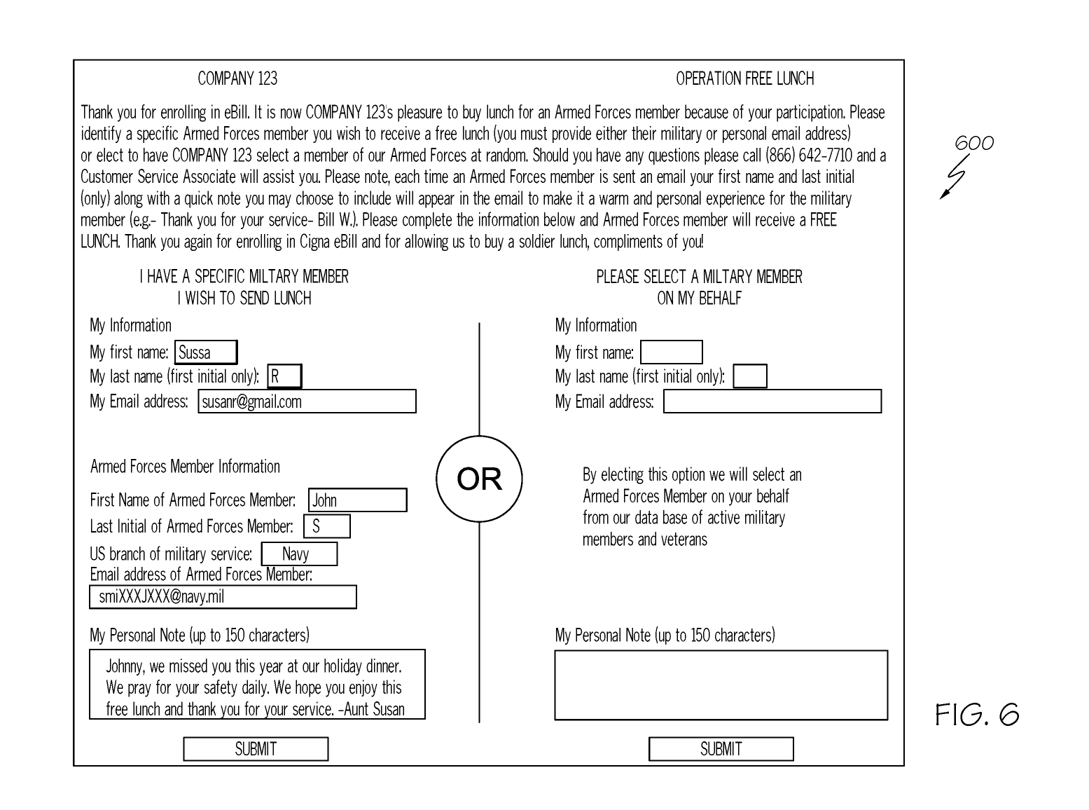

FIG. 6 is an alternate example message 600 inviting a participant to select a recipient and a gift to send from the sponsor. This message 600 would be in addition to and provide further information to the message 400 of FIGS. 4 and 500 of FIG. 5 or in place of it. In the case of a group like a soldier, in one example, the system can select a soldier or military member to receive the gift.

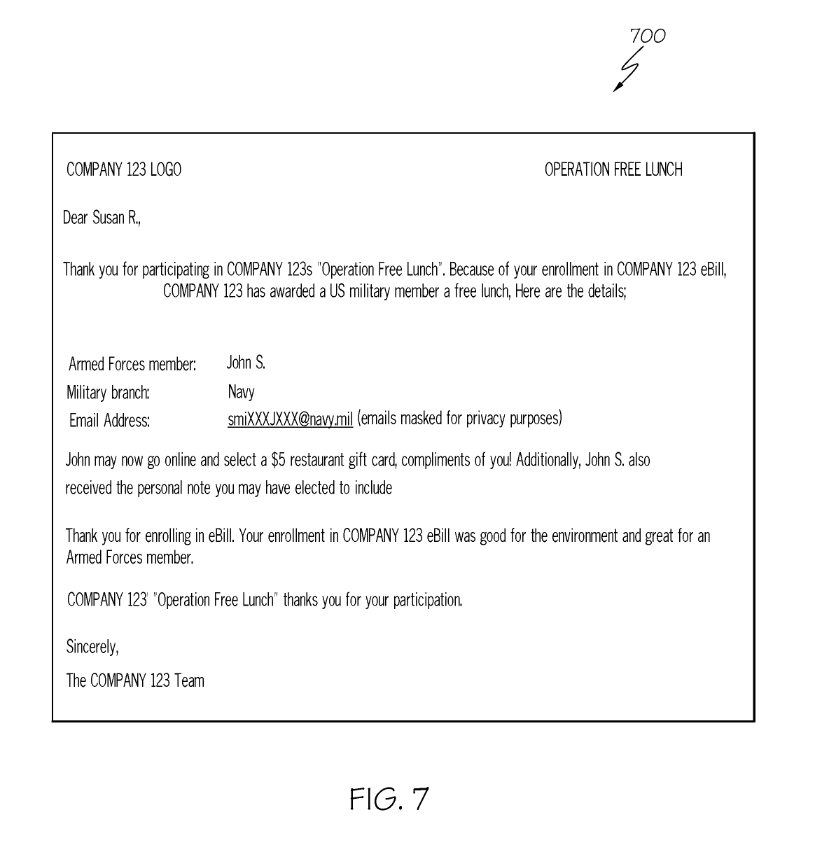

FIG. 7 is an example message 700 notifying the participant that the gift was sent to the recipient. This corresponds to FIG. 3, 322, column 320, row 304 in which the Participant receives an email. This provides positive feedback to the participant.

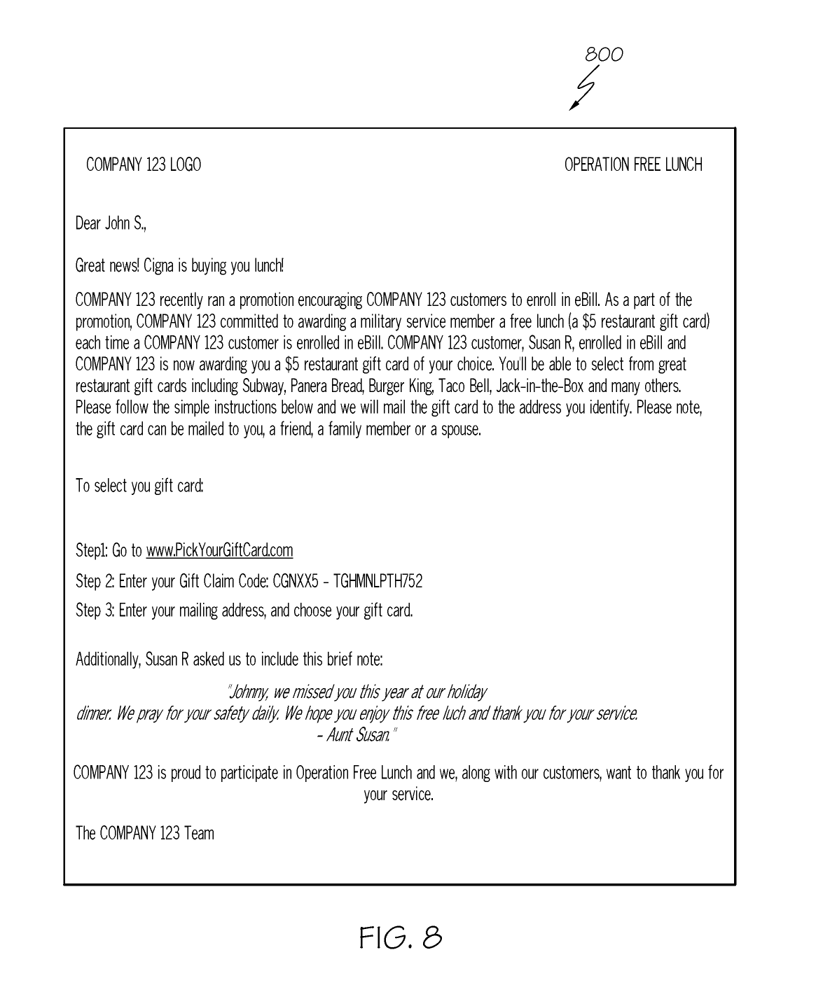

FIG. 8 is an example message 800 notifying the recipient that the gift was sent to them. This corresponds to FIG. 3, 334, column 330, row 306.

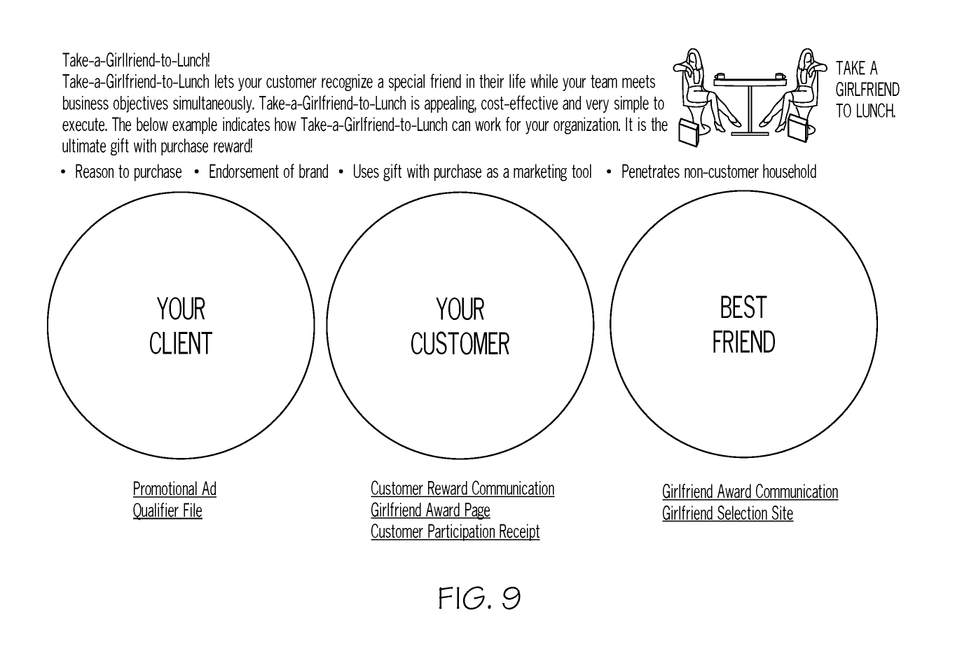

FIG. 9 is an alternate example message inviting a participant to select a joint gift from a sponsor for themselves and a recipient. In this example, lunch discount is given to “Take-a-Girlfriend-Lunch! The participant in this example receives part of the benefit of the gift.

In one example, the gifts are co-branded with both the sponsor's and the participant's branding. The branding takes different forms from promotional ad, customer reward communications, girlfriend award page, customer participation recipient, and more.

### Example Token

A unique token or pin that is assigned to the participant may include one or more several identifying fields as follows:

| | | | | |
|---|---|---|---|---|
| Sponsor | Participant | Participant Zip | Participant | Date and Time |
| | Name | Code | Affiliation Group | Stamp |

In one example, there is a separate token, call it unique token 1, that sponsor uses with a pool of potential participants. There is a second token, call it unique token 2, which the participant uses with the recipient.

These two tokens then can be cross-related so that the sponsor can through a web-based dashboard, see the up-to-the minute data of how many participants have accepted the invitation to send a gift and where the gift process is in general. Stated differently one or more tokens can be used to track all the activities.

### Operational Flow

FIG. 10 is an operational flow diagram 1000 illustrating another example of an overall process for managing giving a gift from a sponsor to a recipient. The operational flow of FIG. 10 beings a step 1002 and flows directly to step 1004. The Gift-It Participant Manager 120, at step 1004, accesses at least one participant from a file (202, 204) that have requested to give a gift from at least one sponsor (152, 154, 156) of the gift to at least one recipient of the gift, where the participant, the sponsor of the gift and the recipient of the gift are all different entities.

Continuing on to step 1006, a unique token is assigned to the participant. An optional test is made whether the participant is also receiving a benefit as lunch as shown in FIG. 9. The token is updated in step 1010 and process continues to step 1012. Otherwise, if the participant is not receiving a benefit, the process continues directly to step 1012 without updating the token.

Next, in step 1012 a first message 312 of FIG. 3, 400 of FIG. 4, 500 of FIG. 5, 600 of FIG. 6, with the unique token is sent to the participant. In step 1010 sending a second message to the recipient that has been identified, the second message including information that the participant is giving the recipient a gift from the sponsor and including information on how to select the gift.

In an optional test 1016 is made to determine if the participant or potential participant selected a gift and recipient per message in step 1012. This test is made after a predetermined period of time has elapsed between the first message being sent in step 1012 and no selection received. This time period can be settable by the administrator of the system to a few days up to several months. If a predetermined period of time has elapsed with not selection received, a reminder is sent in step 1018. The process loops back to step 1016. Once a selection is made the process continues to step 1020. Otherwise, after a number of reminders are sent, the process ends (not shown).

In step 1020, sending a second message 334 of FIG. 3 to the recipient that has been identified, the second message including information that the participant is giving the recipient a gift from the sponsor and including information on how to select the gift.

The step 1022, receiving from the recipient a selection of the gift. Step 1026 sending the gift from the sponsor to the recipient. Process end in step 1028.

### Example Information Processing System

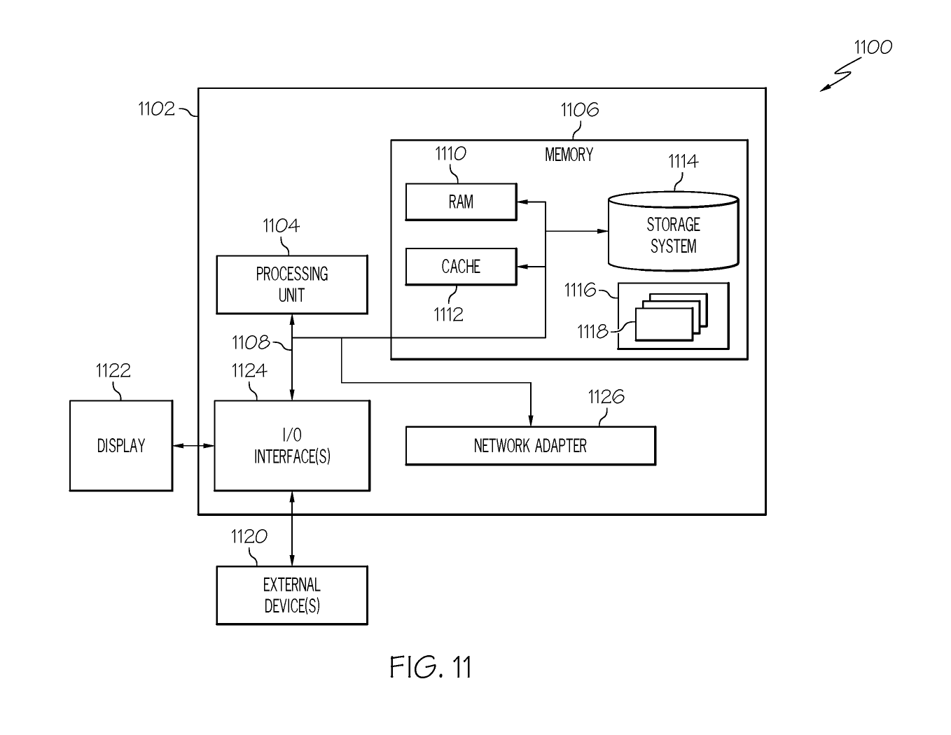

FIG. 11 shows a block diagram illustrating an information processing system 1100 that can be utilized in various examples of the present disclosure such as the information processing systems 110, 120, 130, 152, 154, 156 shown in FIG. 1. The information processing system 1002 is based upon a suitably configured processing system configured to implement one or more examples of the present disclosure. Any suitably configured processing system can be used as the information processing system 1002 in examples of the present disclosure. The components of the information processing system 1002 can include, but are not limited to, one or more processors or processing units 1004, a system memory 1006, and a bus 1008 that couples various system components including the system memory 1006 to the processor 1004.

The bus 1008 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 11, the main memory 1106 includes at the Gift-It Participant Manager 120, its components including the email module 210, the profile manager 212, the communication manager 214 shown in FIG. 2. The participant manager 120 can reside within the processor 1104, or be a separate hardware component. The system memory 1106 can also include computer system readable media in the form of volatile memory, such as random access memory (RAM) 1110 and/or cache memory 1112. The information processing system 1102 can further include other removable/non-removable, volatile/non-volatile computer system storage media. By way of example only, a storage system 1114 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1108 by one or more data media interfaces. The memory 1106 can include at least one program product having a set of program modules that are configured to carry out the functions of an example of the present disclosure.

Program/utility 1116, having a set of program modules 1118, may be stored in memory 1106 by way of example, and not limitation, as well as an operating system, one or more application programs, other program modules, and program data. Each of the operating system, one or more application programs, other program modules, and program data or some combination thereof, may include an implementation of a networking environment. Program modules 1118 generally carry out the functions and/or methodologies of examples of the present disclosure.

The information processing system 1102 can also communicate with one or more external devices 1120 such as a keyboard, a pointing device, a display 1122, etc.; one or more devices that enable a participants 110 and recipients 130 to interact with the information processing system 1102; and/or any devices (e.g., network card, modem, etc.) that enable computer system/server 1102 to communicate with one or more other computing devices. Such communication can occur via I/O interfaces 1124. Still yet, the information processing system 1102 can communicate with one or more networks such as a local area network (LAN), a general wide area network (WAN), and/or a public network (e.g., the Internet) via network adapter 1126. As depicted, the network adapter 1126 communicates with the other components of information processing system 1102 via the bus 1108. Other hardware and/or software components can also be used in conjunction with the information processing system 1102. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present disclosure may be embodied as a system, method, or computer program product. Accordingly, aspects of the present disclosure may take the form of an entirely hardware example, an entirely software example (including firmware, resident software, micro-code, etc.) or an example combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

### Non-Limiting Examples

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. Also, the phrase “such as” is not intended to limit the disclosure to any particular item being referred to. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for managing giving a gift from a sponsor to a recipient, the computer-implemented method comprising:
accessing at least one participant from a file that have requested to give a gift from at least one sponsor of the gift to at least one recipient of the gift, where the participant, the sponsor of the gift and the recipient of the gift are all different entities;
assigning an unique token to the participant;
sending a first message with the unique token to the participant, the first message including instructions on how send the gift to the recipient;
receiving a selection from the participant of an identity of the recipient of the gift;
sending a second message to the recipient that has been identified, the second message including information that the participant is giving the recipient a gift from the sponsor and including information on how to select the gift;
receiving from the recipient a selection of the gift; and
sending the gift from the sponsor to the recipient.

2. The computer-implemented method of claim 1, wherein the second message includes information that the participant is giving the recipient a gift from both the sponsor and the participant.

3. The computer-implemented method of claim 1, further comprising:
sending a third message to the participant that the gift has been sent to the recipient.

4. The computer-implemented method of claim 3, wherein the third message is any of an email message, a text message, a telephone message, and a printed letter.

5. The computer-implemented method of claim 1, wherein the first message is any of an email message, a text message, a telephone message, and a printed letter.

6. The computer-implemented method of claim 1, wherein the second message is any of an email message, a text message, a telephone message, and a printed letter.

7. The computer-implemented method of claim 1, wherein the accessing from the at least one participant from the file includes a set of recipients categorized into active military, veterans, teachers, first responders, a group of people sharing at least one common characteristic, or a combination thereof.

8. The computer-implemented method of claim 7, wherein the accessing from the at least one participant from the file includes the set of recipients includes randomly selecting one participant.

9. The computer-implemented method of claim 1, wherein the unique token associated with the participant is also associated with the sponsor.

10. The computer-implemented method of claim 9, wherein the unique token associated with the participant is also associated with the recipient.

11. The computer-implemented method of claim 1, further comprising:
determining that a pre-set time period has lapsed between a time when the first message with the unique token is sent to the participant and a receiving the selection from the participant of the identity of the recipient of the gift;
in response to the pre-set time period having lapsed, sending a reminder message with the unique token to the participant.

12. An information processing system for managing giving a gift from a sponsor to a recipient, the information processing system comprising:
memory;
a processor communicatively coupled to the memory;
a participant manager, wherein the participant manager is configured to perform
accessing at least one participant from a file that have requested to give a gift from at least one sponsor of the gift to at least one recipient of the gift, where the participant, the sponsor of the gift and the recipient of the gift are all different entities;
assigning an unique token to the participant;
sending a first message with the unique token to the participant, the first message including instructions on how send the gift to the recipient;
receiving a selection from the participant of an identity of the recipient of the gift;
sending a second message to the recipient that has been identified, the second message including information that the participant is giving the recipient a gift from the sponsor and including information on how to select the gift;
receiving from the recipient a selection of the gift; and
sending the gift from the sponsor to the recipient.

13. The information processing system of claim 12, wherein the second message includes information that the participant is giving the recipient a gift from both the sponsor and the participant.

14. The information processing system of claim 12, further comprising:
sending a third message to the participant that the gift has been sent to the recipient.

15. The information processing system of claim 14, wherein the third message is any of an email message, a text message, a telephone message, and a printed letter.

16. The information processing system of claim 12, wherein the first message is any of an email message, a text message, a telephone message, and a printed letter.

17. The information processing system of claim 12, wherein the second message is any of an email message, a text message, a telephone message, and a printed letter.

18. The information processing system of claim 12, wherein the accessing from the at least one participant from the file includes a set of recipients categorized into active military, veterans, teachers, first responders, a group of people sharing at least one common characteristic, or a combination thereof.

19. The information processing system of claim 18, wherein the accessing from the at least one participant from the file includes the set of recipients includes randomly selecting one participant.

20. A non-transitory computer program storage product for managing giving a gift from a sponsor to a recipient, the non-transitory computer program storage product comprising instructions configured to perform
accessing at least one participant from a file that have requested to give a gift from at least one sponsor of the gift to at least one recipient of the gift, where the participant, the sponsor of the gift and the recipient of the gift are all different entities;
assigning an unique token to the participant;
sending a first message with the unique token to the participant, the first message including instructions on how send the gift to the recipient;
receiving a selection from the participant of an identity of the recipient of the gift;
sending a second message to the recipient that has been identified, the second message including information that the participant is giving the recipient a gift from the sponsor and including information on how to select the gift;
receiving from the recipient a selection of the gift; and
sending the gift from the sponsor to the recipient.
